(19) United States
(12) Patent Application Publication
(10) Pub. No.: US 2008/0071016 A1
(43) Pub. Date: Mar. 20, 2008

(54) POLYUREAURETHANE COMPOSITION HAVING IMPROVED COLOR STABILITY

(75) Inventors: David J. Boettcher, McMurray, PA (US); William H. McDonald, Mars, PA (US); Vidhu J. Nagpal, Murrysville, PA (US); Daryl J. Robinson, Monroeville, PA (US); Robert A. Smith, Murrysville, PA (US)

Correspondence Address: Deborah M. Altman;PPG Industries, Inc., Law Department - Intellectual Property, One PPG Place - 39th Floor, Pittsburgh, PA, 15272-0001, US

(73) Assignee: PPG INDUSTRIES OHIO, INC., Cleveland, OH (US)

(21) Appl. No.: 11/844,588

(22) Filed: Aug. 24, 2007

Related U.S. Application Data
(60) Provisional application No. 60/844,526, filed on Sep. 14, 2006.

(51) Int. Cl. C08L 75/04; C08J 3/00

(52) U.S. Cl. 524/284; 524/590

(57) ABSTRACT

The present invention provides a polyureaurethane composition comprising:
a) the reaction product of:
   1) a polyurethane prepolymer comprising a polyisocyanate and at least one OH-containing material; and
   2) an amine-containing curing agent, wherein the equivalent ratio of the amine-containing curing agent of 2) to the polyurethane prepolymer of 1) is from 0.75 to 0.98;
b) a hydroxyphenylbenzotriazole present in the polyureaurethane composition in an amount from 0.75 to 1.1 percent, based on the total weight of resin solids in the polyureaurethane composition; and
c) a multifunctional hindered phenol type anti-oxidant present in an amount from 0.25 to 1.5 percent, based on the total weight of resin solids in the polyureaurethane composition wherein b) and c) are combined in amounts to provide the polyureaurethane composition with a Δ Yellowness Index of less than 1.85 in the 60/80 Accelerated Warehouse Aging Test.

### CROSS REFERENCE TO RELATED APPLICATION

This is a non-provisional application claiming priority under 35 U.S.C. §119(e)(1) of U.S. Provisional Patent Application Ser. No. 60/844,526 filed Sep. 14, 2006.

### FIELD OF THE INVENTION

The present invention relates to polyureaurethane compositions and to methods of improving the color stability thereof.

### BACKGROUND OF THE INVENTION

Optically transparent plastic materials such as polyureaurethane are commonly used in a variety of applications, such as windshields, sunglasses, fashion lenses, non-prescription and prescription lenses, sport masks, face shields and goggles. However, some plastics, because of their chemistry, tend to change color over time, typically by yellowing, due to prolonged exposure to ultraviolet radiation, heat, and/or humidity. Such yellowing is generally considered unacceptable and additives have been developed in order to control color stability. However, few additives are universally effective, and most must be used in combination with others to guarantee color stability over wide ranges of temperatures and humidity levels as well as long term ultraviolet exposure.

Polyureaurethanes are more frequently being considered for use in applications such as lenses because of their superior optical properties and impact resistance. However, they can have a tendency to yellow over time upon storage and after prolonged ultraviolet exposure. In order to take advantage of their optical properties in applications such as eyeglass lenses, where cosmetics are critical, there is a need to develop polyureaurethane compositions having improved color stability.

### SUMMARY OF THE INVENTION

A method of improving color stability of a polyureaurethane article prepared from a polyureaurethane composition is provided, comprising the steps of:

a) providing a polyureaurethane composition comprising the reaction product of the following components:
1) a polyurethane prepolymer comprising a polyisocyanate and at least one OH-containing material, said prepolymer having a NCO/OH equivalent ratio of from 2.0 to 4.5; and
2) an amine-containing curing agent, wherein the equivalent ratio of the amine-containing curing agent of 2) to the polyurethane prepolymer of 1) is from 0.75 to 0.98;

b) adding a hydroxyphenylbenzotriazole to at least one component used to prepare the polyureaurethane composition such that the amount of hydroxyphenylbenzotriazole in the polyureaurethane composition is from 0.75 to 1.1 percent, based on the total weight of resin solids in component 1); and

c) adding a multifunctional hindered phenol type anti-oxidant to at least one component used to prepare the polyureaurethane polymerizate such that the amount of anti-oxidant in the polyureaurethane composition is from 0.25 to 1.5 percent, based on the total weight of resin solids in component 1) wherein the components of b) and c) are combined in amounts to provide the polyureaurethane composition with a Δ Yellowness Index of less than 1.85 in the 60/80 Accelerated Warehouse Aging Test described in the Examples herein.

Also provided is a polyureaurethane composition comprising:

a) the reaction product of the following components:
1) a polyurethane prepolymer comprising the reaction product of a polyisocyanate and at least one OH-containing material, said prepolymer having a NCO/OH equivalent ratio of from 2.0 to 4.5; and
2) an amine-containing curing agent, wherein the equivalent ratio of the amine-containing curing agent of 2) to the polyurethane prepolymer of 1) is from 0.75 to 0.98;

b) a hydroxyphenylbenzotriazole present in an amount from 0.75 to 1.1 percent, based on the total weight of resin solids in component 1); and

c) a multifunctional hindered phenol type anti-oxidant present in an amount from 0.25 to 1.5 percent, based on the total weight of resin solids in component 1) wherein b) and c) are combined in amounts to provide the polyureaurethane composition with a Δ Yellowness Index of less than 1.85 in the 60/80 Accelerated Warehouse Aging Test described in the Examples herein.

### DETAILED DESCRIPTION OF THE INVENTION

It is noted that, as used in this specification and the appended claims, the singular forms “a,” “an,” and “the” include plural referents unless expressly and unequivocally limited to one referent.

By “color stability” is meant the ability of a material or an article to maintain a specific color level, for example yellowness, as measured using standard methods. Such color stability may be measured after testing that is designed to mimic real world conditions; for example, cycled WEATHEROMETER testing that includes prolonged exposure to ultraviolet radiation, heat and humidity of selected levels. Other testing may include only heat and humidity exposure; for example, 40° C./80% relative humidity or 60° C./80% relative humidity over a period ranging from days to years.

For the purposes of this specification, unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

All numerical ranges herein include all numerical values and ranges of all numerical values within the recited numerical ranges. Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements.

By the term “total weight of resin solids” is meant the total weight of all resinous components, in a composition or component, e.g., the polyurethane prepolymer component 1). The term “weight percent” refers to the amount of a component based on the percentage by weight of that component in a composition.

In non-limiting embodiments, the polyureaurethane compositions of the present invention can be used for transparency applications such as architectural glazings, vehicle glazings, riot shields, aircraft canopies, face masks, visors, ophthalmic and sun lenses, protective eyewear, and transparent armor. It has been found that the polyureaurethane articles prepared from the polyureaurethane compositions of the present invention can demonstrate at least one of the following characteristics: optical clarity, good ballistic properties, good chemical resistance, acceptable heat distortion temperatures, and improved color stability during ultraviolet light exposure and long-term storage. The polymerizates resulting from the polyureaurethane compositions (and the articles prepared therefrom) are typically not elastomeric (“non-elastomeric”); i.e., they are not substantially reversibly deformable (e.g., stretchable) due to their rigidity and do not typically exhibit properties characteristic of rubber and other elastomeric polymers.

The polyureaurethane compositions of the present invention have been tested for their Δ Yellowness Index in the 60/80 Accelerated Warehouse Aging Test. In the 60/80 Accelerated Warehouse Aging Test, lenses prepared from the polyureaurethane compositions are exposed to 80% relative humidity at 60° C. for 6 months. The Yellowness Index is measured before and after the 60/80 Accelerated Warehouse Aging Test using ASTM method D-1925 as described in the Examples herein. The difference between the initial and final values for the Yellowness Index is the A Yellowness Index. Compositions of the present invention typically demonstrate a value in a range less than 1.85, i.e., less than 1.85, e.g. is from 1.84 to 0. In other non-limiting embodiments, the Yellowness Index has a value in a range less than 1.75, e.g. from 1.74 to 0; less than 1.65, e.g. from 1.64 to 0; less than 1.10, e.g., from 1.09 to 0; and less than 1.00, e.g., from 0.99 to 0.

Polyisocyanates useful in the preparation of the polyureaurethane of the present invention are numerous and widely varied. Non-limiting examples can include but are not limited to aliphatic polyisocyanates, cycloaliphatic polyisocyanates wherein one or more of the isocyanato groups are attached directly to the cycloaliphatic ring, cycloaliphatic polyisocyanates wherein one or more of the isocyanato groups are not attached directly to the cycloaliphatic ring, aromatic polyisocyanates wherein one or more of the isocyanato groups are attached directly to the aromatic ring, and aromatic polyisocyanates wherein one or more of the isocyanato groups are not attached directly to the aromatic ring, and mixtures thereof. When an aromatic polyisocyanate is used, generally care should be taken to select a material that does not cause the polyureaurethane to color (e.g., yellow).

The polyisocyanate can include but is not limited to aliphatic or cycloaliphatic diisocyanates, aromatic diisocyanates, cyclic dimers and cyclic trimers thereof, and mixtures thereof. Non-limiting examples of suitable polyisocyanates can include but are not limited to Desmodur N 3300 (hexamethylene diisocyanate trimer) which is commercially available from Bayer; Desmodur N 3400 (60% hexamethylene diisocyanate dimer and 40% hexamethylene diisocyanate trimer). The polyisocyanate can include dicyclohexylmethane diisocyanate and isomeric mixtures thereof. As used herein and the claims, the term “isomeric mixtures” refers to a mixture of the cis-cis, trans-trans, and/or cis-trans isomers of the polyisocyanate. Non-limiting examples of isomeric mixtures for use in the present invention can include the trans-trans isomer of 4,4′-methylenebis(cyclohexyl isocyanate), hereinafter referred to as “PICM” (paraisocyanato cyclohexylmethane), the cis-trans isomer of PICM, the cis-cis isomer of PICM, and mixtures thereof.

Suitable isomers for use in the present invention include but are not limited to the following three isomers of 4,4′-methylenebis(cyclohexyl isocyanate).

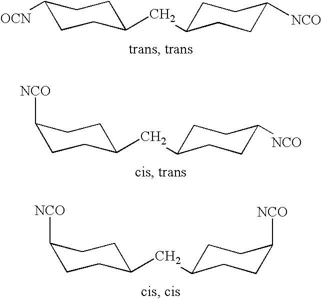

The PICM used in this invention can be prepared, for example, by phosgenating 4,4′-methylenebis(cyclohexyl amine) (PACM) by procedures well known in the art such as the procedures disclosed in U.S. Pat. Nos. 2,644,007; 2,680,127 and 2,908,703; which are incorporated herein by reference. The PACM isomer mixtures, upon phosgenation, can produce PICM in a liquid phase, a partially liquid phase, or a solid phase at room temperature. The PACM isomer mixtures can also be obtained by the hydrogenation of methylenedianiline and/or by fractional crystallization of PACM isomer mixtures in the presence of water and alcohols such as methanol and ethanol.

Additional aliphatic and cycloaliphatic diisocyanates that can be used in the present invention may include 3-isocyanato-methyl-3,5,5-trimethyl cyclohexyl-isocyanate (“IPDI”) which is commercially available from Arco Chemical, and meta-tetramethyl xylene diisocyanate (1,3-bis(1-isocyanato-1-methylethyl)-benzene) which is commercially available from Cytec Industries Inc. under the trade name TMXDI® (Meta) Aliphatic Isocyanate.

As used herein and the claims, the term “aliphatic and cycloaliphatic diisocyanates” typically refers to 6 to 100 carbon atoms linked in a straight chain or cyclized having two diisocyanate reactive end groups. The aliphatic and cycloaliphatic diisocyanates for use in the present invention can include TMXDI and compounds of the formula R—(NCO)₂ wherein R represents an aliphatic group or a cycloaliphatic group.

Suitable OH-containing materials for use in the present invention can include but are not limited to polyether polyols, polyester polyols, polycaprolactone polyols, polycarbonate polyols, and mixtures thereof.

Polyether polyols and methods for their preparation are known to those skilled in the art. Many polyether polyols of various types and molecular weight are commercially available from various manufacturers. Non-limiting examples of polyether polyols can include but are not limited to polyoxyalkylene polyols, and polyalkoxylated polyols. Polyoxyalkylene polyols can be prepared in accordance with known methods. A polyoxyalkylene polyol can be prepared by condensing an alkylene oxide, or a mixture of alkylene oxides, using acid- or base-catalyzed addition with a polyhydric initiator or a mixture of polyhydric initiators, such as but not limited to ethylene glycol, propylene glycol, glycerol, and sorbitol. Non-limiting examples of alkylene oxides can include ethylene oxide, propylene oxide, butylene oxide, amylene oxide, aralkylene oxides, such as but not limited to styrene oxide, mixtures of ethylene oxide and propylene oxide. In a further non-limiting embodiment, polyoxyalkylene polyols can be prepared with mixtures of alkylene oxide using random or step-wise oxyalkylation. Non-limiting examples of such polyoxyalkylene polyols include polyoxyethylene, such as but not limited to polyethylene glycol, polyoxypropylene, such as but not limited to polypropylene glycol.

Polyalkoxylated polyols can be prepared by methods that are known in the art. In a non-limiting embodiment, a polyol such as 4,4′-isopropylidenediphenol can be reacted with an oxirane-containing material such as but not limited to ethylene oxide, propylene oxide and butylene oxide, to form what is commonly referred to as an ethoxylated, propoxylated or butoxylated polyol having hydroxy functionality. Non-limiting examples of polyols suitable for use in preparing polyalkoxylated polyols can include those polyols described in U.S. Pat. No. 6,187,444 B1 at column 10, lines 1-20, which disclosure is incorporated herein by reference.

As used herein and the claims, the term “polyether polyols” can include the generally known poly(oxytetramethylene) diols prepared by the polymerization of tetrahydrofuran in the presence of Lewis acid catalysts such as but not limited to boron trifluoride, tin (IV) chloride and sulfonyl chloride. Also included are the polyethers prepared by the copolymerization of cyclic ethers such as but not limited to ethylene oxide, propylene oxide, trimethylene oxide, and tetrahydrofuran with aliphatic diols such as but not limited to ethylene glycol, 1,3-butanediol, 1,4-butanediol, diethylene glycol, dipropylene glycol, 1,2-propylene glycol and 1,3-propylene glycol. Compatible mixtures of polyether polyols can also be used. As used herein, the term “compatible” means that the polyols are mutually soluble in each other so as to form a single phase.

Polycarbonate polyols are known in the art and are commercially available such as Ravecarb™ 107 (Enichem S.p.A.). In a non-limiting embodiment, the polycarbonate polyol can be produced by reacting an organic glycol such as a diol or such as those described hereinafter and in connection with the glycol component of the polyureaurethane, and a dialkyl carbonate, such as described in U.S. Pat. No. 4,160,853. In a non-limiting embodiment, the polyol can include polyhexamethyl carbonate such as H—(O—C(O)—O—(CH₂)₆)ₙ—OH, wherein n is an integer from 4 to 24, or from 4 to 10, or from 5 to 7.

The glycol material can comprise low molecular weight polyols such as polyols having a molecular weight of less than 500, and compatible mixtures thereof. As used herein, the term “compatible” means that the glycols are mutually soluble in each other so as to form a single phase. Non-limiting examples of these polyols can include but are not limited to low molecular weight diols and triols. The amount of triol chosen may be such as to avoid a high degree of cross-linking in the polyurethane. A high degree of cross-linking can result in a thermoset polyurethane that is not formable by moderate heat and pressure. The organic glycol typically contains from 2 to 16, or from 2 to 6, or from 2 to 10, carbon atoms. Non-limiting examples of such glycols can include but are not limited to ethylene glycol, propylene glycol, diethylene glycol, triethylene glycol, tetraethylene glycol, dipropylene glycol, tripropylene glycol, 1,2-, 1,3- and 1,4-butanediol, 2,2,4-trimethyl-1,3-pentanediol, 2-methyl-1,3-pentanediol, 1,3- 2,4- and 1,5-pentanediol, 2,5- and 1,6-hexanediol, 2,4-heptanediol, 2-ethyl-1,3-hexanediol, 2,2-dimethyl-1,3-propanediol, 1,8-octanediol, 1,9-nonanediol, 1,10-decanediol, 1,4-cyclohexanediol, 1,4-cyclohexanedimethanol, 1,2-bis(hydroxyethyl)-cyclohexane, glycerin, tetramethylolmethane, such as but not limited to pentaerythritol, trimethylolethane and trimethylolpropane; and isomers thereof.

In alternate non-limiting embodiments, the OH-containing material can have a weight average molecular weight of at least 200, or at least 1000, or at least 2000. In alternate non-limiting embodiments, the OH-containing material can have a weight average molecular weight of less than 10000, or less than 15000, or less than 20000, or less than 32000.

In a non-limiting embodiment, suitable polyester glycols can include but are not limited to the esterification products of one or more dicarboxylic acids having from four to ten carbon atoms, such as adipic, succinic or sebacic acids, with one or more low molecular weight glycols having from two to ten carbon atoms, such as ethylene glycol, propylene glycol, diethylene glycol, 1,4-butanediol, neopentyl glycol, 1,6-hexanediol and 1,10-decanediol. In a non-limiting embodiment, the polyester glycols can be the esterification products of adipic acid with glycols of from two to ten carbon atoms.

Suitable polycaprolactone glycols for use in the present invention can include but are not limited to the reaction products of ε-caprolactone with one or more of the low molecular weight glycols listed above. A polycaprolactone can be prepared by condensing caprolactone in the presence of a difunctional active hydrogen compound such as water or at least one of the low molecular weight glycols listed above.

The OH-containing material for use in the present invention can include teresters produced from at least one low molecular weight dicarboxylic acid, such as adipic acid.

Polyester glycols and polycaprolactone glycols for use in the present invention can be prepared using known esterification or transesterification procedures as described, for example, in the article D. M. Young, F. Hostettler et al., “Polyesters from Lactone,” Union Carbide F-40, p. 147.

Polyester glycols can also be prepared from the reaction of 1,6-hexanediol and adipic acid; 1,10-decandiol and adipic acid; or 1,10-decanediol and caprolactone.

Polyether glycols for use in the present invention can include but are not limited to polytetramethylene ether glycol.

The polyether-containing polyol can comprise block polymers including blocks of ethylene oxide-propylene oxide and/or ethylene oxide-butylene oxide. Typically the weight average molecular weight of such a polyol does not exceed 32,000.

For example, Pluronic R, Pluronic L62D, Tetronic R and Tetronic, which are commercially available from BASF, can be used as the polyether-containing polyol material in the present invention.

Also, for example, the OH-containing material for use in the present invention can be chosen from: (a) esterification product of adipic acid with at least one diol selected from 1,4-butanediol, 1,6-hexanediol, neopentyl glycol, or 1,10-decanediol; (b) reaction product of E-caprolactone with at least one diol selected from 1,4-butane diol, 1,6-hexane diol, neopentyl glycol, or 1,10-decanediol; (c) polytetramethylene glycol; (d) aliphatic polycarbonate glycols, and (e) mixtures thereof.

In the present invention, the equivalent ratio of NCO (i.e., isocyanate) to OH present in the polyurethane prepolymer can be an amount of from 2.0 to 4.5 NCO/1.0 OH. Also, the equivalent ratio of NCO (i.e., isocyanate) to OH present in the polyurethane prepolymer can be an amount of from 2.0 to less than 2.5 NCO/1.0 OH such as from 2.0 to 2.4; or from 2.5 to 4.5 NCO/1.0 OH.

Suitable amine-containing curing agents for use in the present invention are numerous and widely varied. Non-limiting examples include polyamines having more than one amino group per molecule, each amino group being independently selected from primary amino (—NH₂) and secondary amine (—NH—) groups. The amine-containing curing agent can be chosen from aliphatic polyamines, cycloaliphatic polyamines, aromatic polyamines, and mixtures thereof. The amino groups may all be primary groups. To produce a polyureaurethane having low color, the amine-curing agent can be chosen such that it has relatively low color and/or it can be manufactured and/or stored in a manner as to prevent the amine from developing a color (e.g., yellow).

Suitable amine-containing curing agents for use in the present invention can include but are not limited to materials having the following chemical formula:

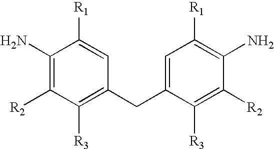

wherein R₁ and R₂ can each be independently chosen from methyl, ethyl, propyl, and isopropyl groups, and R₃ can be chosen from hydrogen and chlorine. Non-limiting examples of amine-containing curing agents for use in the present invention include the following compounds, manufactured by Lonza Ltd. (Basel, Switzerland):

LONZACURE® M-DIPA: R₁═C₃ H₇; R₂═C₃ H₇; R₃═H

LONZACURE® M-DMA: R₁═CH₃; R₂═CH₃; R₃═H

LONZACURE® M-MEA: R₁═CH₃; R₂═C₂ H₅; R₃═H

LONZACURE® M-DEA: R₁═C₂ H₅; R₂═C₂ H₅; R₃═H

LONZACURE® M-MIPA: R₁═CH₃; R₂═C₃ H₇; R₃═H

LONZACURE® M-CDEA: R₁═C₂ H₅; R₂═C₂ H₅; R₃═Cl

wherein R₁, R₂ and R₃ correspond to the aforementioned chemical formula.

The amine-containing curing agent can include but is not limited to a diamine curing agent such as 4,4′-methylenebis(3-chloro-2,6-diethylaniline), (LONZACURE® M-CDEA), which is available in the United States from Air Products and Chemical, Inc. (Allentown, Pa.). In alternate non-limiting embodiments, the amine-containing curing agent for use in the present invention can include 2,4-diamino-3,5-diethyl-toluene, 2,6-diamino-3,5-diethyl-toluene and mixtures thereof (collectively “diethyltoluenediamine” or “DETDA”), which is commercially available from Albemarle Corporation under the trade name Ethacure 100; dimethylthiotoluenediamine (DMTDA), which is commercially available from Albemarle Corporation under the trade name Ethacure 300; 4,4′-methylene-bis-(2-chloroaniline) which is commercially available from Kingyorker Chemicals under the trade name MOCA.

DETDA can be a liquid at room temperature with a viscosity of 156 cPs at 25° C. DETDA can be isomeric, with the 2,4-isomer range being from 75 to 81 percent while the 2,6-isomer range can be from 18 to 24 percent.

The amine-containing curing agent for use in the present invention can be chosen from DEDTA, compounds having the following structure

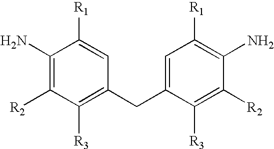

and mixtures thereof.

There are various known methods for preparing polyureaurethane. The polyureaurethane of the present invention can be prepared by one shot, quasi-prepolymer or full prepolymer methods, all of which are known in the art and disclosed in U.S. Pat. No. 5,962,617; which disclosure is herein incorporated by reference. In the one shot method, all of the reactants can be mixed together at one time. In the quasi-prepolymer method, generally 30 to 80 percent of the total amount of polyol is reacted with the polyisocyanate to form a prepolymer, and then the remaining 20 to 70 percent of the polyol can be added to the prepolymer with the amine-containing curing agent. The polyisocyanate (i.e., NCO) can be mixed with an OH-containing material and heated to a temperature within the range of from 190° F. to 300° F. The period of time for heating the mixture can vary greatly. Generally, at lower temperatures the mixture can be heated for a longer period of time than can be employed at higher temperatures. For example, at a temperature of from 260 to 265° F., the mixture can be heated for 5 to 10 hours, and at a temperature of from 275 to 290° F., for a period of 3 to 5 hours. The mixture can be heated under dry nitrogen to facilitate the reaction of the polyisocyanate with the OH-containing material to form a prepolymer. The heat source can then be removed and the prepolymer can be cooled. In a further non-limiting embodiment, the prepolymer can be cooled to a temperature of 160° F. The prepolymer can be allowed to remain at that temperature for about 24 hours. The NCO present in the prepolymer then can be determined by a variety of methods known in the art such as ASTM-D-2572-91.

The NCO present in the prepolymer can be determined as follows. A 2-gram sample of the polyureaurethane can be added to an Erlenmeyer flask. The sample can be purged with nitrogen and several glass beads (5 mm) then can be added. To this mixture can be added 20 mL of 1N dibutylamine (in toluene) with a pipette. The mixture can be swirled and capped. The flask then can be placed on a heating source and the flask can be heated to slight reflux, held for 15 minutes at this temperature and then cooled to room temperature. A piece of Teflon can be placed between the stopper and joint to prevent pressure buildup while heating. During the heating cycle, the contents can be frequently swirled in an attempt for complete solution and reaction. Blank values can be obtained and determined by the direct titration of 20 mL of pipetted 1N dibutylamine (DBA) plus 50 mL of methanol with 1N hydrochloric acid (HCl) using the TITRINO 751 dynamic autotitrator. The average values for the HCl normalities and DBA blanks can be calculated, and the values can be programmed into the autotitrator. After the sample has cooled, the contents can be transferred into a beaker with approximately 50 to 60 mL of methanol. A magnetic stirring bar can be added and the sample can be titrated with 1N HCl using a preprogrammed TITRINO 751 autotitrator. The percent NCO and IEW (isocyanate equivalent weight) can be calculated in accordance with the following formulas:

% NCO=(mLs blank-mLs sample)(Normality HCl)(4.2018)/sample wt., grams;

IEW=(sample wt., grams) 1000/(mLs blank-mLs sample)(Normality HCl).

The “Normality HCl” value can be determined as follows. To a pre-weighed beaker can be added 0.4 grams of Na₂CO₃ primary standard and the weight can be recorded. To this can be added 50 mL of deionized water and the Na₂CO₃ can be dissolved with magnetic stirring. The TITRINO 751 autotitrator can be used to titrate the primary standard with the 1N HCl and the volume can be recorded. This procedure can be repeated two additional times for a total of three titrations and the average can be used as the normality according to the following formula:

Normality HCl=standard wt., grams/(mLs HCl)(0.053).

In a non-limiting embodiment of the present invention, additional polyisocyanate can be added to the polyurethane prepolymer to achieve a different (e.g., higher or lower) equivalent weight of NCO/OH. The can then be reacted at a temperature of from 70° F. to 300° F., with an amine-containing curing agent such as a diamine curing agent. In alternative non-limiting embodiments, the amine-containing curing agent can be present in an equivalent ratio of from 0.60 to 1.20 NH₂/1.0 NCO, or 0.75 to 0.98 NH₂/1.0 NCO, or 0.85 to 0.95 NH₂/1.0 ISOCYANATE, or 0.85 to 0.90 NH₂/1.0 NCO. The polyureaurethane can then be cured at a temperature of from 230 to 300° F. for a period of from 4 to 24 hours.

Suitable urethane-forming catalysts can be used in the present invention to enhance the reaction of the polyurethane-forming materials. Suitable urethane-forming catalysts can be those catalysts that are specific for the formation of urethane by reaction of the NCO and OH-containing materials, and which have little tendency to accelerate side reactions leading to allophonate and isocyanate formation. Non-limiting examples of suitable catalysts can be chosen from the group of Lewis bases, Lewis acids and insertion catalysts as described in Ullmann's Encyclopedia of Industrial Chemistry, 5^{th} Edition, 1992, Volume A21, pp. 673 to 674. In a non-limiting embodiment, the catalyst can be a stannous salt of an organic acid, such as but not limited to stannous octoate, dibutyl tin dilaurate, dibutyl tin diacetate, dibutyl tin mercaptide, dibutyl tin dimaleate, dimethyl tin diacetate, dimethyl tin dilaurate, 1,4-diazabicyclo[2.2.2]octane, and mixtures thereof. In alternate non-limiting embodiments, the catalyst can be zinc octoate, bismuth, or ferric acetylacetonate.

Further non-limiting examples of suitable catalysts can include tertiary amines such as but not limited to triethylamine, triisopropylamine and N,N-dimethylbenzylamine. Such suitable tertiary amines are disclosed in U.S. Pat. No. 5,693,738 at column 10, lines 6-38, the disclosure of which is incorporated herein by reference.

The catalyst can be incorporated into the amine-containing curing agent. The amount of catalyst can vary widely depending on the particular catalyst chosen. The amount of catalyst can be less than 5% by weight, or less than 3% by weight, or less than 1% by weight, based on the total weight of the reaction mixture. For example, dibutyltin dilaurate can be employed in amounts of from 0.0005 to 0.02 parts per 100 parts of the polyurethane-forming materials. The amount of catalyst used can be dependent on the curing temperature employed.

The polyureaurethane of the present invention can have a viscosity of less than 2,000 cPs, or less than 1,500 cPs at 73° C. as measured using a Brookfield Viscometer. The viscosity of the prepolymer can be dependent on the particular polyisocyanate and OH-containing material chosen.

The polyureaurethane of this invention can be formed into an article, for example, an optical element, by a variety of methods including but not limited to casting, compression molding, extruding or injection molding. In a non-limiting embodiment, the polyureaurethane can be cast into lenses. Casting of the polyureaurethane can produce a lens having good optical characteristics. In the casting process, the polyurethane prepolymer and amine-containing curing agent mixture can be cast into a mold prior to curing. The polyureaurethane of the invention can be partially cured, by choosing an appropriate curing time and temperature, and then the polyureaurethane can be removed from the casting molds and formed into a desired shape. The polyureaurethane can be formed into a simple or complex shape and can then be fully cured.

The polyureaurethane of this invention can be formed into an article, for example, an optical element, by a variety of methods including but not limited to casting, compression molding, extruding or injection molding. In a non-limiting embodiment, the polyureaurethane can be cast into lenses. Casting of the polyureaurethane can produce a lens having good optical characteristics with little or no variation in color over time upon storage and/or exposure to UV radiation.

The lens formed from the polyureaurethane composition of the present invention can be coated on the front side and/or backside with any of a variety of protective coatings known in the art, e.g., an abrasion-resistant coating such as an organo-silane-type abrasion-resistant coating that is known in the art to protect plastic surfaces from abrasions and scratches. Organo-silane abrasion-resistant coatings can be referred to as hard coats and are known in the art. Various organo-silane hard coatings are disclosed in U.S. Pat. No. 4,756,973 at column 5, lines 1-45; and U.S. Pat. No. 5,462,806 at column 1, lines 58 through column 2, line 8 and column 3, line 52 through column 5, line 50, which disclosures are incorporated herein by reference. Further non-limiting examples of organo-silane hard coatings are disclosed in U.S. Pat. Nos. 4,731,264; 5,134,191; and 5,231,156 which disclosures are also incorporated herein by reference. In a non-limiting embodiment, the front side and backside of the lens can be coated with SDC 1154 which is commercially available from SDC Coatings, Incorporated or Hi-Gard 1080 which is commercially available from PPG Industries, Incorporated. In a non-limiting embodiment, front side and/or backside of the lens can be coated with an ultraviolet light curable hard coat such as but not limited to UVX and UVNVS which are commercially available from UltraOptics.

Other coatings that provide abrasion and scratch resistance, such as polyfunctional acrylic hard coatings, melamine-based hard coatings, urethane-based hard coatings, alkyl-based coatings, silica sol-based hard coatings or other organic or inorganic/organic hybrid hard coatings can be used as the abrasion-resistant coating.

In a further non-limiting embodiment, additional coatings such as antireflective coatings and/or polarizing coatings can be applied to the articles formed from the polyureaurethane compositions of the present invention. Examples of antireflective coatings are described in U.S. Pat. No. 6,175,450, the disclosure of which is incorporated herein by reference. In a non-limiting embodiment, the front side and/or backside of the lens can be coated with Essilor's Reflection Free anti-reflective coating which can be applied using Essilor's Reflection Free Process.

In a non-limiting embodiment, the front side of the lens can be coated with the SDC-1154 hard coat, the backside of the lens can be coated with the UVNVS hard coat, and then both the front side and the backside can be coated with Essilor's Reflection Free anti-reflective coating.

In general, the impact resistance of an uncoated lens can be higher than the impact resistance of a coated lens. The application of a hard coat to the lens can result in a decrease in the impact strength of the lens. The impact strength can be further decreased by the application of an antireflective coating onto the hard coated lens. The amount of decrease in the impact strength can be dependent on the particular hard and antireflective coatings selected for application to the lens.

The polymerizates (or articles) prepared from the polyureaurethane compositions of the present invention can have a good impact resistance. In alternate non-limiting embodiments, the polyureaurethane composition when at least partially cured and tested as a lens having a thickness of from 2.0 to 2.2 mm and having a hard coating on both surfaces, can withstand an impact of at least 148 feet per second, or at least 170 feet per second, or at least 300 feet per second, as measured by the High Impact Test Procedure. As used herein and the claims, the “High Impact Test Procedure” refers to the following procedure which is conducted in accordance with Z87.1-200X, Sep. 12, 2002, Committee Ballot Draft Revision of ANSI Z87.1-1989 (R1998), sections 7.5.2.1 “High Velocity Impact” and 14.3 “Test for High Impact Prescription Lenses”. A Universal Lens Tester (ULT-II) as manufactured by International Certification Services Laboratories, Incorporated is used in the procedure. Piano power lenses having a maximum base curve of 6.25 can be edged round with an industrial safety bevel to a diameter of 55 mm+0.04 mm/−0.25 mm. Each lens can be tested once with a new lens being used for each additional impact. Each lens can be mounted in a test holder such that the test lens is held firmly against the bevel of the lens holder. The high velocity impact test includes propelling a missile at a velocity of 150 feet per second on the center of each lens. The missile consists of a 6.35 mm (0.25 inch) diameter steel ball (obtained from Applied Industrial Technologies) weighing 1.06 gram (0.037 ounce). The test can be repeated with two additional sample lenses. The lens can be considered to have failed the test if there is any posterior displacement of the lens completely through the test holder; any fracture of the lens; any detachment of a portion of the lens from its inner surface; or any full thickness penetration of a lens. As used herein, “fracture” refers to a crack through the entire thickness of the lens into two or more separate pieces, or detachment from the inner surface of any lens material visible to the naked eye. Failure of any one lens constitutes a failure.

Small amounts of at least one tri-functional or higher functional polyol such as but not limited to a triol, tetrol, pentrol and mixtures thereof can be added to the components used to form the polyurethane prepolymer in an amount sufficient to produce cross-linking based upon equivalents of reactants. At least one of these materials can be added to produce at least 0.01 percent, or at least 0.5 percent, or less than 99 percent, or less than 5 percent cross-linking by weight based on the total reactants. Suitable non-limiting examples include trimethylol propane, trimethylol ethane, glycerine, pentaerythritol, dipentaerythritol, sorbitol, sucrose, mannitol, and mixtures thereof. Further non-limiting examples include these materials chain extended with ethylene, propylene or butylenes oxide. The addition of at least one of these materials to the prepolymer can increase the heat distortion temperature and in some cases can improve the ballistic properties of the cured polyurethane.

A hydroxyphenylbenzotriazole UV-stabilizer is present in the polyureaurethane composition of the present invention in an amount ranging from 0.75 to 1.1 percent, or from 0.9 to 1.1 percent, such as 1 percent based on the total weight of resin solids in the prepolymer component 1). The UV-stabilizer can be added to the prepolymer either prior to or during the curing step. Suitable UV-stabilizers for use in the present invention include 2-(2H-benzotriazol-2-yl)-4,6-ditertpentylphenol sold under the name TINUVIN® 328, commercially available from Ciba Geigy; a 2-(2′-hydroxy-5′-octylphenyl)-benzotriazole sold under the name CYASORB® UV-5411 from CYTEC INDUSTRIES INC and mixtures thereof.

Suitable phosphorus-containing stabilizer materials that can be used include phosphites such as sodium hypophosphite, Irganox. TM. B215 (67% tris(2,4-ditert-butylphenyl) phosphite and 33% pentaerythrityl tetrakis(3,5-ditert-butyl-4-hydroxyphenyl propionate)), Irganox™ 168 (tris(2,4-ditert-butylphenyl)phosphite), which are commercially available from Ciba-Geigy Corp. and Ultranox 626 which is commercially available from GE Specialty Chemicals.

Further non-limiting examples of phosphorus-containing stabilizer materials include phosphites such as trisalkyl phosphites having long or branched alkyl groups, triaryl phosphites such a triphenyl phosphite (TPP) which can also have alkyl substituents, such as tris(p-nonylphenyl) phosphite (TNPP), mixed aryl alkyl phosphites, such as bis-(2,4-di-t-butylphenyl)-pentaerythrityl disphosphite, tris-(2,4-di-t-butylphenyl)-pentaerythrityl disphosphite, distearyl pentaerythrityl disphosphite and 2,2′-methylene-bis (4,6-di-tert-butylphenyl)octylphosphite (commercially available as Mark HP-10 from Argus Chemical Co.), phosphates such as tetrakis(2,4-di-t-butylphenyl)-4,4′-biphenyldiphosphate, phosphonates such as sodium benzene phosphonate, and fluorophosphonites such as 2,2′-ethylidene-bis(4,6-di-t-butylphenyl)fluorophosphonite (commercially available as Ethanox. RTM. 398 from Ethyl Corporation). Such phosphorus-containing may be present in an amount ranging from 0.25 to 1.5 percent, or from 0.30 to 1.0 percent, based on the total weight of resin solids in the prepolymer component 1).

Suitable anti-oxidants that can be used in the present invention can include any of a variety of anti-oxidants known in the art. In one embodiment, suitable anti-oxidants can include but are not limited to those of the multifunctional hindered phenol type. One non-limiting example of a multifunctional hindered phenol type anti-oxidant can include benzenepropanoic acid, 3,5-bis(1,1-dimethylethyl)-4-hydroxy-,2,2-bis[[3-[3,5-bis(1,1-dimethylethyl)-4-hydroxyphenyl]-1-oxopropoxy]methyl]-1,3-propanediyl ester (IRGANOX 1010), which is commercially available from Ciba Geigy. The anti-oxidant is present in an amount ranging from 0.25 to 1.5 percent, or from 0.5 to 1.0 percent, based on the total weight of resin solids in the prepolymer component 1).

In an embodiment of the present invention, the polyureaurethane composition is essentially free of hindered amine light stabilizer. Hindered amine light stabilizers (HALS) are well known in the art, and detailed descriptions of such HALS can be found in U.S. Pat. No. 5,391,327 at column 3, line 60 to column 5, line 36; and U.S. Pat. No. 5,770,115 at column 4, lines 15-32, the cited portions of which are incorporated herein by reference. One particular example of a HALS is LOWALITE® 92 available from Great Lakes Chemical Corporation. As used herein, by “essentially free of hindered amine light stabilizer” is meant that the composition comprises less than 0.5 percent of hindered amine light stabilizer, such as less than 0.4 percent, or less than 0.3 percent or less than 0.2 percent of hindered amine light stabilizer based on the total weight of resin solids in the prepolymer component.

The polyureaurethane composition of the present invention can be used in producing a photochromic article. United States patent applications having Ser. Nos. 09/793,886 and 09/794,026 both filed on Mar. 20, 2000 and pending in the United States Patent and Trademark Office, disclose the production of photochromic articles. These two applications are incorporated herein by reference.

When used to prepare photochromic articles, e.g., lenses, the polyureaurethane polymerizate should be transparent to that portion of the electromagnetic spectrum which activates the photochromic substance(s) incorporated in the matrix, i.e., that wavelength of ultraviolet (UV) light that produces the colored or open form of the photochromic substance and that portion of the visible spectrum that includes the absorption maximum wavelength of the photochromic substance in its UV activated form, i.e., the open form. Photochromic substances that may be utilized with the polyureaurethane compositions of the present invention can include organic photochromic compounds or substances containing same that may be incorporated, e.g., dissolved, dispersed or diffused into articles prepared from the polyureaurethane compositions.

A first group of organic photochromic substances contemplated for use to form the photochromic articles of the present invention are those having an activated absorption maximum within the visible range of greater than 590 nanometers, e.g., from 590 to 700 nanometers. These materials typically exhibit a blue, bluish-green, or bluish-purple color when exposed to ultraviolet light in an appropriate solvent or matrix. Non-limiting examples of classes of such substances that are useful in the present invention include but are not limited to spiro(indoline)naphthoxazines and spiro(indoline)benzoxazines. These and other classes of such photochromic substances are known. See, for example, U.S. Pat. Nos.: 3,562,172; 3,578,602; 4,215,010; 4,342,668; 5,405,958; 4,637,698; 4,931,219; 4,816,584; 4,880,667; 4,818,096.

A second group of organic photochromic substances contemplated for use to form the photochromic articles of the present invention are those having at least one absorption maximum and two absorption maxima, within the visible range of between 400 and less than 500 nanometers. These materials typically exhibit a yellow-orange color when exposed to ultraviolet light in an appropriate solvent or matrix. Such compounds include but are not limited to certain chromenes, i.e., benzopyrans and naphthopyrans. Many of such chromenes are known, e.g., U.S. Pat. Nos. 3,567,605; 4,826,977; 5,066,818; 4,826,977; 5,066,818; 5,466,398; 5,384,077; 5,238,931; and 5,274,132.

A third group of organic photochromic substances contemplated for use to form the photochromic articles of the present invention are those having an absorption maximum within the visible range of between 400 to 500 nanometers and another absorption maximum within the visible range of between 500 to 700 nanometers. These materials typically exhibit color(s) ranging from yellow/brown to purple/gray when exposed to ultraviolet light in an appropriate solvent or matrix. Non-limiting examples of these substances include certain benzopyran compounds, having substituents at the 2-position of the pyran ring and a substituted or unsubstituted heterocyclic ring, such as a benzothieno or benzofurano ring fused to the benzene portion of the benzopyran. Such materials are described in U.S. Pat. No. 5,429,774.

Other photochromic substances contemplated include photochromic organo-metal dithizonates, i.e., (arylazo)-thioformic arylhydrazidates, e.g., mercury dithizonates which are described in, for example, U.S. Pat. No. 3,361,706. Fulgides and fulgimides, e.g. the 3-furyl and 3-thienyl fulgides and fulgimides which are described in U.S. Pat. No. 4,931,220 at column 20, line 5 through column 21, line 38.

The specified disclosures relating to such photochromic substances in the afore-described patents are incorporated herein by reference. The photochromic articles of the present invention may contain one photochromic substance or a mixture of photochromic substances. Mixtures of photochromic substances may be used to attain certain activated colors such as a near neutral gray or brown.

Each of the photochromic substances described herein may be used in amounts and in a ratio (when mixtures are used) such that a polyurethane/polymerizate to which the mixture of compounds is applied or in which they are incorporated exhibits a desired resultant color, e.g., a substantially neutral color such as shades of gray or brown when activated with unfiltered sunlight, i.e., as near a neutral color as possible given the colors of the activated photochromic substances. The relative amounts of the aforesaid photochromic substances used will vary and depend in part upon the relative intensities of the color of the activated species of such compounds, and the ultimate color desired.

The photochromic compounds or substances described herein may be applied to or incorporated into the polyureaurethane polymerizate (e.g. lenses) by various methods described in the art. Such methods include but are not limited to dissolving or dispersing the substance within the polymerizate or article after it is at least partially cured as discussed above, e.g., imbibition of the photochromic substance into the polymerizate or article by immersion of the polymerizate or article in a hot solution of the photochromic substance or by thermal transfer; providing the photochromic substance as a separate layer between adjacent layers of the polymerizate, e.g., as a part of a polymer film; and applying the photochromic substance as a coating or as part of a coating placed on the surface of the polyurethane/polymerizate. The term “imbibition” or “imbibe” is intended to mean and include permeation of the photochromic substance alone into the polyurethane/polymerizate, solvent assisted transfer absorption of the photochromic substance into a porous polymer, vapor phase transfer, and other such transfer mechanisms. One non-limiting example of an imbibing method includes the steps of coating the photochromic article with the photochromic substance; heating the surface of the photochromic article; and removing the residual coating from the surface of the photochromic article.

The amount of photochromic substance or composition containing the same applied to or incorporated into the polymerizate or article is not critical provided that a sufficient amount is used to produce a photochromic effect discernible to the naked eye upon activation. Generally such amount can be described as a photochromic amount. The particular amount used depends often upon the intensity of color desired upon irradiation thereof and upon the method used to incorporate or apply the photochromic substances. Typically, the more photochromic substance applied or incorporated, the greater is the color intensity. Generally, the amount of total photochromic substance incorporated into or applied to a photochromic optical polyurethane/polymerizate may range from 0.15 to 0.35 milligrams per square centimeter of surface to which the photochromic substance(s) is incorporated or applied.

It is also contemplated that photochromic substances can be added to one or both of components 1) and 2) prior to polymerizing, e.g., cast curing, the polyureaurethane composition. However, when this is done it is typical that the photochromic substance(s) is resistant to potentially adverse interactions with, for example, initiator(s) that may be present and/or any of the components of the prepolymer or the amine components. These adverse interactions can result in deactivation of the photochromic substance(s), e.g., by trapping them in either an open or closed form. Photochromic substances can also include photochromic pigments and organic photochromic substances encapsulated in metal oxides, the latter of which are described, for example, in U.S. Pat. Nos. 4,166,043 and 4,367,170. Organic photochromic substances sufficiently encapsulated within a matrix of an organic polyurethane/polymerizate, as described in U.S. Pat. No. 4,931,220, can also be incorporated into the multi-component composition of the present invention prior to curing. If photochromic substances are added to the multi-component organic composition of the present invention prior to curing, they are typically incorporated into the second component prior to mixing the first and second components together.

Also provided by the present invention is a method of improving color stability of an article prepared from a polyureaurethane composition comprising:

a) providing a polyureaurethane polymerizate comprising the reaction product of the following components:
1) a polyurethane prepolymer comprising a polyisocyanate and at least one OH-containing material, said prepolymer having a NCO/OH equivalent ratio of from 2.0 to 4.5; and
2) an amine-containing curing agent, wherein the equivalent ratio of the amine-containing curing agent of 2) to the polyurethane prepolymer of 1) is from 0.75 to 0.98;

b) adding a hydroxyphenylbenzotriazole to at least one component used to prepare the polyureaurethane polymerizate such that the amount of hydroxyphenylbenzotriazole in the polyureaurethane composition is from 0.75 to 1.1 percent, or from 0.9 to 1.1 percent, based on the total weight of resin solids in the prepolymer components 1); and

c) adding a multifunctional hindered phenol type anti-oxidant to at least one component used to prepare the polyureaurethane polymerizate such that the amount of anti-oxidant in the polyureaurethane composition is from 0.25 to 1.5 percent, or from 0.5 to 1.0 percent, based on the total weight of resin solids in the prepolymer component 1) wherein b) and c) are combined in amounts to provide the polyureaurethane composition with a Δ Yellowness Index of less than 1.85 in the 60/80 Accelerated Warehouse Aging Test.

In this method, the various components may be any of those disclosed above. Each of the hydroxyphenylbenzotriazole and multifunctional hindered phenol type anti-oxidant may be added to at least one component used to prepare the polyureaurethane polymerizate and may be added at any time before or during cure thereof. They may be added separately to the same or different components, all at once or in stages. They may be added together as a package, again, all at once or in stages. Often they are added as a package to the polyurethane prepolymer prior to its reaction with the amine-containing curing agent.

### EXAMPLES 1A/B-4A/B AND 5-11 AND COMPARATIVE EXAMPLES 1-19

The lenses prepared from the Examples and Comparative Examples were made using a combination of Component A and Component B which were mixed in a Urethane Processor as described below. Duplicates of formulations were designated with an “A” or “B” after the Example number, otherwise single lenses were prepared and tested.

### Part A

The masterbatch of Component A included TRIVEX® AY curable resin available from PPG Industries, which was prepared without any stabilizers or additives. The materials listed in Table 1 for each Example and Comparative Example (CE) were added in the weight percents indicated to portions of the masterbatch of Component A maintained under vacuum at 65° C. and mixed at the maximum setting on the Urethane Processor Model # 601-000-316 from Max Machinery for 16 hours. Also added to the masterbatch of Component A was 1.3 ppm of EXALITE® Blue 7813 from Exciton Company and 300 ppm of a mold release agent, ZELEC® UN, reported to be a C₈ to C₁₆ alkyl phosphate ester, from Stepan Company.

### Part B

Component B was Ethacure 100 reported to be 2,4-diamino-3,5-diethyl-toluene, 2,6-diamino-3,5-diethyl-toluene and mixtures thereof from Albemarle Corporation.

### Part C

Component A and Component B were added to the Urethane Processor and mixed with high shear for a short period of time. Component B and Component A were present in a molar ratio of 0.85 to 1.0. The blended mixture was then injected into 6 base piano semi-finished lens molds that produced a lens having a thickness of 8.5 mm and a diameter of 81 mm. The molds were placed in a convection oven and the temperature was ramped up from 85° C. to 130° C. in 30 minutes; and held for sixteen hours at a temperature of 130° C.; and ramped down from 130° C. to 85° C. in 30 minutes. Afterwards the lenses were demolded and allowed to cool at room temperature for 2.5 hours before testing.

### Part D

The lenses of Part C were tested for an initial Yellowness index, placed in a Humidity chamber, Espec Model EX-111 from Tabai Espec Company, maintained at 60° C. and 80 percent humidity for 6 months and tested for a final Yellowness Index in the 60/80 Accelerated Warehouse Aging Test. The change in the Yellowness Index is reported as the A Yellowness Index in Table 1.

Yellowness index testing was done in accordance with ASTM D 1925-70 (Reapproved 1988) Test Method for Yellowness Index of Plastics (Withdrawn 1995) using a HunterLab® Colorquest® II Sphere Colorimeter System (Hunter Associates Laboratory, Inc., Reston, Va., USA). The results listed in Table 1 show that the lenses of Examples 1A/B-4A/B and 5-11 demonstrated a lower Δ Yellowness index in the 60/80 Accelerated Warehouse Aging Test than Comparative Examples 1-19.

TABLE 1
Test Results

| | | Irganox ® | Tinuvin ® | Lowilite ® | Tinuvin ® | Cyasorb ® | 60/80 Accelerated |
|---|---|---|---|---|---|---|---|
| | | 1010⁽¹⁾ | 328⁽²⁾ | 92⁽³⁾ | B 75⁽⁴⁾ | UV-5411⁽⁵⁾ | Warehouse Aging |
| ID | Run # | Wt % | Wt % | Wt % | Wt % | Wt % | Δ Yellowness Index |
| 1A | 17 | 0.75 | 0.75 | 0 | 0 | 0 | 1.64 |
| 1B | 25 | 0.75 | 0.75 | 0 | 0 | 0 | 1.28 |
| 2A | 18 | 0.75 | 1.00 | 0 | 0 | 0 | 1.58 |
| 2B | 31 | 0.75 | 1.00 | 0 | 0 | 0 | 1.63 |
| 3A | 19 | 1.00 | 0.75 | 0 | 0 | 0 | 1.60 |
| 3B | 27 | 1.00 | 0.75 | 0 | 0 | 0 | 1.09 |
| 4A | 20 | 1.00 | 1.00 | 0 | 0 | 0 | 1.56 |
| 4B | 33 | 1.00 | 1.00 | 0 | 0 | 0 | 1.67 |
| 5 | 21 | 1.25 | 1.00 | 0 | 0 | 0 | 1.55 |
| 6 | 22 | 1.50 | 1.00 | 0 | 0 | 0 | 1.59 |
| 7 | 23 | 0.50 | 0.75 | 0 | 0 | 0 | 1.28 |
| 8 | 29 | 0.50 | 1.00 | 0 | 0 | 0 | 1.54 |
| 9 | 35 | 0.50 | 0 | 0 | 0 | 0.75 | 1.84 |
| 10 | 37 | 0.75 | 0 | 0 | 0 | 0.75 | 1.80 |
| 11 | 39 | 1.00 | 0 | 0 | 0 | 0.75 | 1.68 |
| CE1 | 1 | 0.49 | 0.92 | 0.92 | 0 | 0 | 4.61 |
| CE2 | 2 | 0.75 | 0.25 | 0.25 | 0 | 0 | 2.22 |
| CE3 | 3 | 0.75 | 0.50 | 0.50 | 0 | 0 | 3.03 |
| CE4 | 4 | 0.75 | 0.75 | 0.75 | 0 | 0 | 4.06 |
| CE5 | 5 | 0.75 | 1.00 | 1.00 | 0 | 0 | 4.12 |
| CE6 | 6 | 1.00 | 0.25 | 0.25 | 0 | 0 | 2.05 |
| CE7 | 7 | 1.00 | 0.50 | 0.50 | 0 | 0 | 3.25 |
| CE8 | 8 | 1.00 | 0.50 | 0.50 | 0 | 0 | 3.31 |
| CE9 | 9 | 1.00 | 1.00 | 1.00 | 0 | 0 | 4.41 |
| CE10 | 10 | 0.75 | 0.25 | 1.00 | 0 | 0 | 4.76 |
| CE11 | 11 | 0.75 | 1.00 | 0.25 | 0 | 0 | 2.63 |
| CE12 | 12 | 1.00 | 0.25 | 1.00 | 0 | 0 | 4.73 |
| CE13 | 13 | 1.00 | 1.00 | 0.25 | 0 | 0 | 2.52 |
| CE14 | 14 | 0 | 0 | 0 | 3.25 | 0 | 5.21 |
| CE15 | 15 | 0 | 0 | 0 | 3.50 | 0 | 4.99 |
| CE16 | 16 | 0 | 0 | 0 | 3.75 | 0 | 5.34 |
| CE17 | 41 | 0.50 | 0 | 0 | 0 | 1.00 | 2.31 |
| CE18 | 43 | 0.75 | 0 | 0 | 0 | 1.00 | 2.31 |
| CE19 | 45 | 1.00 | 0 | 0 | 0 | 1.00 | 2.44 |

⁽¹⁾IRGANOX ® 1010 is reported to be a phenolic based antioxidant from CIBA Specialty Chemicals.
⁽²⁾TINUVIN ® 328 is reported to be a UV absorber of the hydroxyphenylbenzotriazole class from CIBA Specialty Chemicals.
⁽³⁾LOWILITE ® 92 is reported to be a light stabilizer of the Hindered Amine Light Stabilizers (HALS) family from Great Lakes Chemical Corporation.
⁽⁴⁾TINUVIN ® B 75 is reported to be a synergistic blend of IRGANOX ® 1135, TINUVIN ® 571 and TINUVIN ® 765 from CIBA Specialty Chemicals.
⁽⁵⁾CYASORB ® UV-5411 is reported to be a 2-(2′-hydroxy-5′-octylphenyl)-benzotriazole from CYTEC INDUSTRIES INC.

Whereas the present invention has been described with reference to specific details of particular embodiments thereof. It is not intended that such details be regarded as limitations upon the scope of the invention except insofar as and to the extent that they are included in the appended claims.

What is claimed is:

1. A method of improving color stability of an article prepared from a polyureaurethane composition comprising:
a) providing a polyureaurethane composition comprising the reaction product of the following components:
1) a polyurethane prepolymer comprising a polyisocyanate and at least one OH-containing material, said prepolymer having a NCO/OH equivalent ratio of from 2.0 to 4.5; and
2) an amine-containing curing agent, wherein the equivalent ratio of the amine-containing curing agent of 2) to the polyurethane prepolymer of 1) is from 0.75 to 0.98;
b) adding a hydroxyphenylbenzotriazole to at least one component used to prepare the polyureaurethane composition such that the amount of hydroxyphenylbenzotriazole in the polyureaurethane composition is from 0.75 to 1.1 percent, based on the total weight of resin solids in the prepolymer components 1); and
c) adding a multifunctional hindered phenol type anti-oxidant to at least one component used to prepare the polyureaurethane composition such that the amount of anti-oxidant in the polyureaurethane composition is from 0.25 to 1.5 percent, based on the total weight of resin solids in the prepolymer component 1) wherein the components of b) and c) are combined in amounts to provide the polyureaurethane composition with a Δ Yellowness Index of less than 1.85 in the 60/80 Accelerated Warehouse Aging Test.

2. The method of claim 1 wherein said polyisocyanate comprises 4,4′-methylenebis(cyclohexyl isocyanate).

3. The method of claim 1 wherein said OH-containing material comprises a polycaprolactone polyol.

4. The method of claim 1 wherein said OH-containing material further comprises trimethylol propane.

5. The method of claim 1 wherein said prepolymer has a NCO/OH equivalent ratio of from 2.0 to less than 2.5.

6. The method of claim 1 wherein said prepolymer has a NCO/OH equivalent ratio of from 2.5 to 4.5.

7. The method of claim 1 wherein said amine-containing curing agent comprises diethylene toluenediamine.

8. The method of claim 1 wherein the equivalent ratio of the amine-containing curing agent of 2) to the polyurethane prepolymer of 1) is from 0.85 to 0.95.

9. The method of claim 1 wherein the equivalent ratio of the amine-containing curing agent of 2) to the polyurethane prepolymer of 1) is from 0.85 to 0.90.

10. The method of claim 1 wherein said hydroxyphenylbenzotriazole comprises 2-(2H-benzotriazol-2-yl)-4,6-ditertpentylphenol, 2-(2′-hydroxy-5′-octylphenyl)-benzotriazole or mixtures thereof.

11. The method of claim 1 wherein the amount of hydroxyphenylbenzotriazole in the polyureaurethane composition is from 0.9 to 1.1 percent, based on the total weight of resin solids in the prepolymer component 1).

12. The method of claim 1 wherein said multifunctional hindered phenol type anti-oxidant comprises benzenepropanoic acid, 3,5-bis(1,1-dimethylethyl)-4-hydroxy-,2,2-bis[[3-[3,5-bis(1,1-dimethylethyl)-4-hydroxyphenyl]-1-oxopropoxy]methyl]-1,3-propanediyl ester.

13. The method of claim 1 wherein the amount of anti-oxidant in the polyureaurethane composition is from 0.5 to 1.0 percent, based on the total weight of resin solids in the prepolymer component 1).

14. The method of claim 1 wherein the hydroxyphenylbenzotriazole is added to the polyurethane prepolymer component 1).

15. The method of claim 1 wherein the anti-oxidant is added to the polyurethane prepolymer component 1).

16. The method of claim 1 wherein the hydroxyphenylbenzotriazole and anti-oxidant are added together to the polyurethane prepolymer component 1).

17. A polyureaurethane composition comprising:
a) the reaction product of the following components:
1) a polyurethane prepolymer comprising a polyisocyanate and at least one OH-containing material, said prepolymer having a NCO/OH equivalent ratio of from 2.0 to 4.5; and
2) an amine-containing curing agent, wherein the equivalent ratio of the amine-containing curing agent of 2) to the polyurethane prepolymer of 1) is from 0.75 to 0.98;
b) a hydroxyphenylbenzotriazole present in the polyureaurethane composition in an amount from 0.75 to 1.1 percent, based on the total weight of resin solids in the prepolymer component 1); and
c) a multifunctional hindered phenol type anti-oxidant present in an amount from 0.25 to 1.5 percent, based on the total weight of resin solids in the prepolymer component 1) wherein b) and c) are combined in amounts to provide the polyureaurethane composition with a Δ Yellowness Index of less than 1.85 in the 60/80 Accelerated Warehouse Aging Test.

18. The composition of claim 1 wherein said polyisocyanate comprises 4,4′-methylenebis(cyclohexyl isocyanate).

19. The composition of claim 17 wherein said OH-containing material comprises a polycaprolactone polyol.

20. The composition of claim 17 wherein said OH-containing material further comprises trimethylol propane.

21. The composition of claim 17 wherein said prepolymer has a NCO/OH equivalent ratio of from 2.0 to less than 2.5.

22. The composition of claim 17 wherein said prepolymer has a NCO/OH equivalent ratio of from 2.5 to 4.5.

23. The composition of claim 17 wherein said amine-containing curing agent comprises diethylene toluenediamine.

24. The composition of claim 17 wherein the equivalent ratio of the amine-containing curing agent of 2) to the polyurethane prepolymer of 1) is from 0.85 to 0.95.

25. The composition of claim 17 wherein the equivalent ratio of the amine-containing curing agent of 2) to the polyurethane prepolymer of 1) is from 0.85 to 0.90.

26. The composition of claim 17 wherein said hydroxyphenylbenzotriazole comprises 2-(2H-benzotriazol-2-yl)-4,6-ditertpentylphenol, 2-(2′-hydroxy-5′-octylphenyl)-benzotriazole or mixtures thereof.

27. The composition of claim 17 wherein the amount of hydroxyphenylbenzotriazole in the polyureaurethane composition is from 0.9 to 1.1 percent, based on the total weight of resin solids in the prepolymer component 1).

28. The composition of claim 17 wherein said multifunctional hindered phenol type anti-oxidant comprises benzenepropanoic acid, 3,5-bis(1,1-dimethylethyl)-4-hydroxy-,2,2-bis[[3-[3,5-bis(1,1-dimethylethyl)-4-hydroxyphenyl]-1-oxopropoxy]methyl]-1,3-propanediyl ester.

29. The composition of claim 17 wherein the amount of anti-oxidant in the polyureaurethane composition is from 0.5 to 1.0 percent, based on the total weight of resin solids in the prepolymer component 1).

30. The method of claim 1, wherein the polyureaurethane composition is essentially free of hindered amine light stabilizer.

31. The polyureaurethane composition of claim 17, wherein the polyureaurethane composition is essentially free of hindered amine light stabilizer.
